(19) United States
(12) Patent Application Publication
(10) Pub. No.: US 2021/0078566 A1
(43) Pub. Date: Mar. 18, 2021

(54) HYBRID VEHICLE

(71) Applicant: TOYOTA JIDOSHA KABUSHIKI KAISHA, Toyota-shi (JP)

(72) Inventor: Yuki OGAWA, Toyota-shi (JP)

(73) Assignee: TOYOTA JIDOSHA KABUSHIKI KAISHA, Toyota-shi (JP)

(21) Appl. No.: 17/012,208

(22) Filed: Sep. 4, 2020

(30) Foreign Application Priority Data
Sep. 18, 2019 (JP) 2019-169485

(51) Int. Cl. B60W 20/12; B60L 58/13; B60W 50/14

(52) U.S. Cl. CPC B60W 20/12; B60L 58/13; G01C 21/34; B60W 2050/146; B60W 2510/246; B60W 50/14

(57) ABSTRACT

There is provided a hybrid vehicle to suppress switching between a motor drive and a hybrid drive in a short time. The hybrid vehicle includes an engine, motor, battery, map information, and a control device programmed to set a drive route from a current location to a destination, to create a drive support plan that assigns one of drive modes including a CD mode and a CS mode to each of drive sections of the drive route, and to perform drive support control. The hybrid vehicle does not perform the drive support control until elapse of a predetermined time period since the system activation or since the termination of the drive support control. This suppresses switching between the motor drive and the hybrid drive in a short time immediately after the system activation or immediately after the termination of the drive support control.

### CROSS-REFERENCE TO RELATED APPLICATIONS

The present disclosure claims priority to Japanese Patent Application No. 2019-169485 filed Sep. 18, 2019, which is incorporated herein by reference in its entirety including specification, drawings and claims.

### TECHNICAL FIELD

The present disclosure relates to a hybrid vehicle for managing an application of a plurality of drive modes.

### BACKGROUND

A conventionally known hybrid vehicle of this type performs a drive support control for driving the hybrid vehicle along with a drive support plan in each of drive sections of a drive route from a current location to a destination (as described in, for example, JP2014-151760A). The drive support plan is created by assigning one of a motor drive (EV drive) mode in which an engine is stopped and the hybrid vehicle is driven with a power from a motor, and a hybrid drive (HV drive) mode in which the hybrid vehicle is driven with a power from an engine and a power from a motor during operation of the engine. The drive support plan is created to assign the motor drive mode and the hybrid drive mode such that a state of charge SOC (SOC: State of Charge) that is a ratio of remaining capacity of a battery becomes equal to a value 0 when the hybrid vehicle reaches the destination.

### SUMMARY

In the hybrid vehicle, hunting may occur by switching between the motor drive and the hybrid drive in a short time due to execution of the driving support control. Generally, motor drive is often set in a system activation of hybrid vehicle. When the drive support control is performed immediately after the system activation, however, the motor drive may be immediately switched to the hybrid drive. When a new drive support control is performed immediately after the termination of the drive support control for some reason, the motor drive may be switched to the hybrid drive when terminating the drive support control and the hybrid drive may be switched to the motor drive by the new drive support control performed immediately after the switching. Switching between the motor drive and the hybrid drive in such a short time may cause a user to feel strange.

The hybrid vehicle of the present disclosure mainly aims to suppress switching between motor drive and hybrid drive in a short time.

In order to achieve the above primary object, the hybrid vehicle of the present disclosure employs the following configuration.

The present disclosure is directed to a first hybrid vehicle. The hybrid vehicle includes an engine, a motor, a battery, map information, and a control device programmed to set a drive route from a current location to a destination, to create a drive support plan that assigns one of drive modes including a CD mode and a CS mode to each of drive sections of the drive route, and to perform drive support control that causes the hybrid vehicle to be driven along the drive support plan. The control device is not programmed to perform the drive support control until a predetermined time period has elapsed since a system activation or a termination of the drive support control.

In the first hybrid vehicle of the present disclosure, the control device does not perform the drive support control until the predetermined time period has elapsed since the system activation or until the predetermined time period has elapsed since the termination of the drive support control. This suppresses the switching of the drive mode in a short time by performing the drive support control immediately after the system activation. Further, the control device performs a new drive support control immediately after the termination of the drive support control. This suppresses switching between a motor drive (EV drive) and a hybrid drive (HV drive) in a short time. The CD mode (Charge Depleting mode) gives a priority to the motor drive to reduce a state of charge SOC of the battery. The CS mode (Charge Sustaining mode) uses the motor drive and the hybrid drive in combination to maintain the state of charge SOC of the battery. In the motor drive, the hybrid vehicle is driven only by the power from the motor while the engine is stopped. In the hybrid drive, the hybrid vehicle is driven by the power from the engine and the motor during operation of the engine. When the hybrid vehicle is equipped with a driving state indicator configured to light up during the motor drive or the hybrid drive, an instantaneous lighting and blinking of the driving state indicator can be suppressed.

### BRIEF DESCRIPTION OF DRAWINGS

FIG. 1 is a block diagram illustrating an example of a configuration of a hybrid vehicle focusing on a hybrid electronic control unit according to a first embodiment of the present disclosure;

FIG. 2 is a flow chart showing one example of a drive support control performed by the hybrid electronic control unit according to the first embodiment of the present disclosure;

FIG. 3 is a flow chart showing one example of a drive support control performed by the hybrid electronic control unit according to the second embodiment of the present disclosure, and

FIG. 4 is a flow chart showing one example of a drive support control performed by the hybrid electronic control unit according to the third embodiment of the present disclosure.

### DESCRIPTION OF EMBODIMENTS

The following describes some aspects of the present disclosure with reference to several embodiments.

### First Embodiment

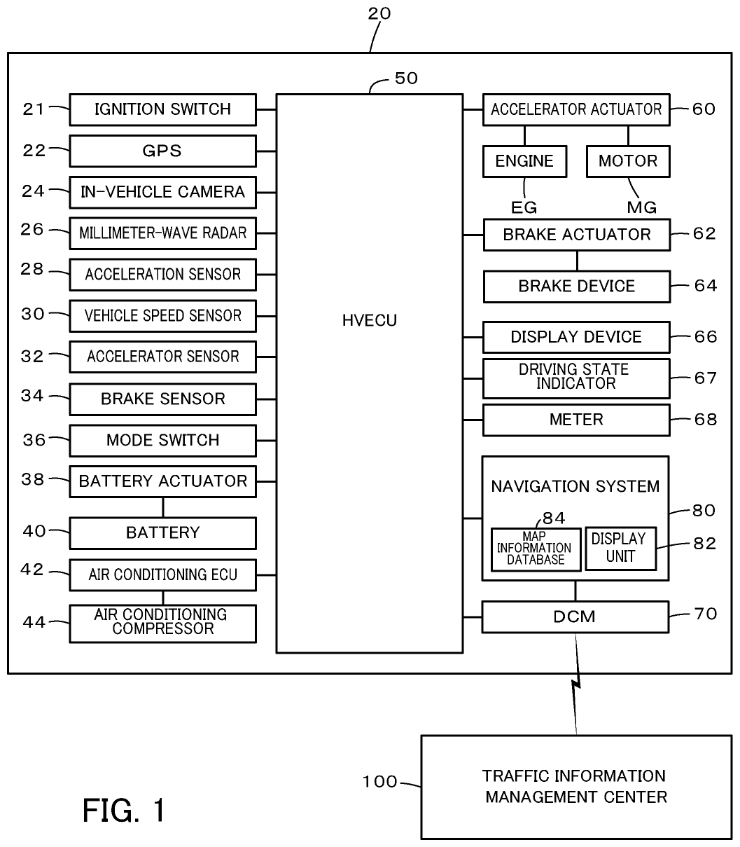

FIG. 1 is a block diagram illustrating an example of a configuration of a hybrid vehicle 20 focusing on a hybrid electronic control unit (hereinafter referred as “HVECU”) 50 according to an embodiment of the present disclosure. The hybrid vehicle 20 of the embodiment includes an engine EG and a motor MG as a power source. The hybrid vehicle 20 of the embodiment is driven by switching between a CD mode (Charge Depleting mode) and a CS mode (Charge Sustaining mode). In the CD mode, the motor drive is prioritized to reduce the state of charge SOC of a battery 40. In the CS mode, the motor drive and the hybrid drive are combined to maintain the state of charge SOC of the battery 40 at a target ratio. In the motor drive, the hybrid vehicle 20 is driven only by the power from the motor MG while the engine EG is stopped. In the hybrid drive, the hybrid vehicle 20 is driven by the power from the engine EG and the motor MG during operation of the engine 20.

The hybrid vehicle 20 of the embodiment includes an ignition switch 21, a GPS (Global Positioning System, Global Positioning Satellite) 22, an in-vehicle camera 24, a millimeter-wave radar 26, an acceleration sensor 28, a vehicle speed sensor 30, an accelerator sensor 32, a brake sensor 34, a mode switch 36, a battery actuator 38, the battery 40, an air conditioning electronic control unit (hereinafter referred to as an air conditioning ECU) 42, an air conditioning compressor 44, the HVECU 50, an accelerator actuator 60, a brake actuator 62, a brake device 64, a display device 66, a driving state indicator 67, a meter 68, a DCM (Data Communication Module) 70, and a navigation system 80 in addition to the power source.

The GPS 22 is a device for detecting a position of a vehicle based on signals transmitted from a plurality of GPS satellites. The in-vehicle camera 24 is a camera that captures an image of the surroundings of the vehicle, and corresponds to, for example, a front camera that captures an image of the front of the vehicle, and a rear camera that captures an image of the rear of the vehicle. The millimeter-wave radar 26 detects a distance and a relative speed between the own vehicle and a vehicle ahead. The millimeter-wave radar 26 also detects a distance and a relative speed between the own vehicle and a vehicle behind.

The acceleration sensor 28 is, for example, a sensor for detecting acceleration in the longitudinal direction of the vehicle and detecting acceleration in the lateral direction of the vehicle. The vehicle speed sensor 30 detects vehicle speed based on wheel speed or the like. The accelerator sensor 32 detects accelerator position or the like according to a depression amount of an accelerator pedal by the driver. The brake sensor 34 detects a brake position or the like as a depression amount of a brake pedal by the driver. The mode switch 36 switches between the CD mode and the CS mode, and is arranged in the vicinity of a steering wheel of the driver's seat.

The battery actuator 38 detects various states of the battery 40, for example, a voltage between terminals, a charge/discharge current, and a battery temperature. The battery actuator 38 is configured to control the battery 40 based on a detected value. The battery actuator 38 calculates the state of charge SOC as a ratio of the remaining capacity of electric power dischargeable from the battery to the overall capacity of the battery based on the charge/discharge current. The battery actuator 38 also calculates an allowable maximum output power (output limit Wout) as to be output from the battery 40 and an allowable maximum input power (input limit Win) as to be input into the battery 40 based on the calculated state of charge SOC, the battery temperature, and the like. The battery 40 is configured as a chargeable and dischargeable secondary battery, and for example, a lithium ion battery, a nickel metal hydride battery, or a lead storage battery may be used.

The air conditioning ECU 42 is configured as a CPU-based microprocessor (CPU: not shown). The air conditioning ECU 42 also includes, for example, a ROM, a RAM, a flash memory, input/output ports, and a communication port. The air conditioning ECU 42 is incorporated in an air conditioning system configured to condition air in the passenger compartment. The air conditioning ECU 42 drives and controls the air conditioning compressor 44 in the air conditioning system such that the temperature of the passenger compartment becomes the set temperature.

The engine EG is configured, for example, as an internal combustion engine. The motor MG is configured, for example, as an electric motor that also functions as a generator such as a synchronous motor. The motor MG is connected to the battery 40 via an inverter (not shown), and outputs driving force by using electric power supplied from the battery 40 or charges the battery 40 with the generated electric power.

The HVECU 50 is configured as a CPU-based microprocessor (CPU: not shown). The HVECU 50 also includes, for example, a ROM, a RAM, a flash memory, input/output ports, and a communication port. The HVECU 50 sets a drive mode. The HVECU 50 also sets a target drive point (target rotation speed or target torque) of the engine EG and a torque command of the motor MG based on the set drive mode, the accelerator position from the accelerator sensor 32, the brake position from the brake sensor 34, and the input/output limit from the battery actuator 38.

The HVECU 50 performs the following processing when the hybrid vehicle is driven in the motor drive. The HVECU 50 sets a required driving force and a required power based on the accelerator position from the accelerator sensor 32 and the vehicle speed from the vehicle speed sensor 30. The HVECU 50 sets the torque command of the motor MG to output the required driving force and the required power to the vehicle. The HVECU 50 transmits the set torque command to the accelerator actuator 60. The HVECU 50 performs the following processing when the hybrid vehicle is driven in a hybrid drive. The HVECU 50 sets the target drive point of the engine EG and the torque command of the motor MG to output the required driving force and the required power to the vehicle. The HVECU 50 transmits the target drive point and the torque command to the accelerator actuator 60. The HVECU 50 performs the following processing in response to a depression of the brake pedal by the driver. The HVECU 50 sets the required braking force based on the brake position from the brake sensor 34 and the vehicle speed from the vehicle speed sensor 30. The HVECU 50 sets a regenerative torque command for regenerative control of the motor MG and a target braking force by the brake device based on the required braking force and the vehicle speed. The HVECU 50 transmits the torque command to the accelerator actuator 60 and transmits the target braking force to the brake actuator 62.

The accelerator actuator 60 drives and controls the engine EG and the motor MG in accordance with the target drive point and the torque command set by the HVECU 50. The accelerator actuator 60 performs intake air flow control, fuel injection control, ignition control, intake valve opening/closing timing control and the like to operate the engine EG at the target operation point (target rotation speed or target torque). Further, the accelerator actuator 60 performs switching control of the switching element of the inverter for driving the motor MG such that a torque corresponding to the torque command is output from the motor MG.

The brake actuator 62 controls the brake device 64 such that the target braking force set by the HVECU 50 is applied to the vehicle by the brake device 64. The brake control device 64 is configured, for example, as a hydraulically driven friction brake.

The display device 66 is incorporated in, for example, an installation panel in front of the driver's seat. The display device 66 displays various information. The driving state indicator 67 includes an EV indicator (not shown) and an HV indicator (not shown). The driving state indicator 67 turns on the EV indicator and turns off the HV indicator during a motor drive. The driving state indicator 67 turns off the EV indicator and turns on the HV indicator during a hybrid drive. The meter 68 is incorporated in, for example, the installation panel in front of the driver's seat.

The DCM (Data Communication Module) 70 transmits information on the own vehicle to a traffic information management center 100 and receives road traffic information from the traffic information management center 100. The information on the own vehicle includes, for example, a position, a vehicle speed, a driving power and a drive mode of the own vehicle. The road traffic information includes, for example, information on current and future traffic congestion, information on current average vehicle speed and predicted value of future average vehicle speed in each of drive sections of the drive route, information on traffic regulation, information on weather conditions, information on road conditions, and map information. The DCM 70 communicates with the traffic information management center 100 at every predetermined time interval (for example, every 30 seconds, every minute, every two minutes).

The navigation system 80 is configured to guide the own vehicle to a set destination. The navigation system 80 includes a display unit 82 and a map information database 84. The navigational system 80 communicates with the traffic information management center 100 via the DCM 70. When the destination is set, the navigation system 80 sets the route based on information on the destination, information on the current location (current location of the own vehicle) received from the GPS 22, and information stored in the map information data base 84. The navigation system 80 communicates with the traffic information management center 100 at every predetermined time interval (for example, every 3 minutes or every 5 minutes) to obtain road traffic information and performs route guidance based on the road traffic information.

When the route guidance is performed, the navigation system 80 generates a read-ahead information, such as a load information necessary for driving of each drive section, and transmits the read-ahead information to the HVECU 50 every time (or at every predetermined time interval) the road traffic information is obtained from the traffic information management center 100. The read-ahead information is generated based on, for example, information on each of drive sections of the drive route in the road traffic information obtained from the traffic information management center 100, information on driving load, the vehicle speed of the own vehicle, the driving power of the own vehicle, and the drive mode of the own vehicle. The HVECU 50 creates a drive support plan that assigns one of drive modes including the CD mode and the CS mode to each of drive sections of the drive route using the read-ahead information received from the navigation system 80 when the drive support control can be performed, and performs the drive support plan.

When update information included in the map information is obtained from the traffic information management center 100, the navigation system 80 displays the item “map update” on the display unit 82 and announces “Map information is ready to be updated. Please press the map update button.” or the like. When the item “map update” is operated in response to the notification of the map update, the navigation system 80 communicates with the traffic information management center 100 via the DCM 70, obtains the map information related to the map update, and stores the map information in the map information database 84. When the map information is updated, the navigation system 80 announces “Some functions are stopped during update of map information.” or the like.

The navigational system 80 counts an alive counter Cnb that increments by a value 1 at every predetermined time interval to inform the HVECU 50 or the like that the navigation system 80 is normally activated. The HVECU 50 obtains the alive counter Cnb from the navigation system 80 at every predetermined time interval and confirms that the navigation system 80 is normally activated. According to the embodiment, the navigation system 80 does not count the alive counter Cnb as a stop function during the update of the map information. The HVECU 50 counts an alive counter Chv that increments by a value 1 at every predetermined time interval to inform the navigation system 80 or the like that the navigation system is normally activated. The navigation system 80 obtains the alive counter Chv from the HVECU 50 at every predetermined time interval and confirms that the HVECU 50 is normally activated.

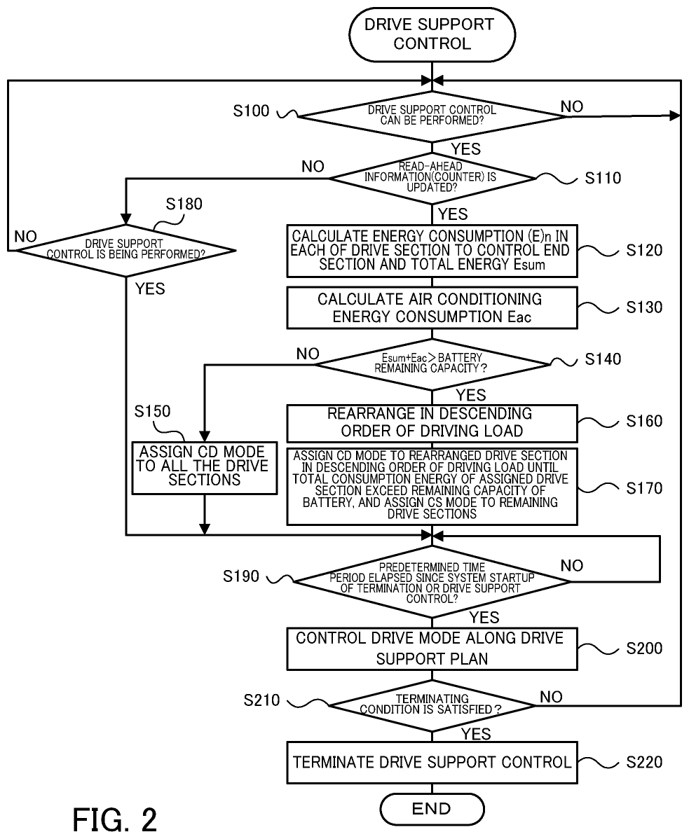

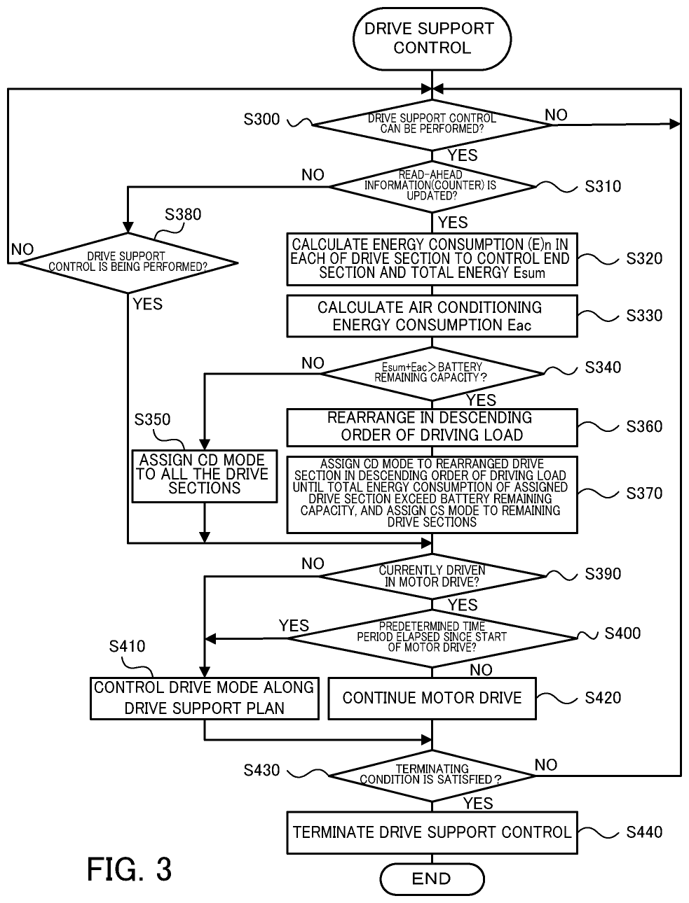

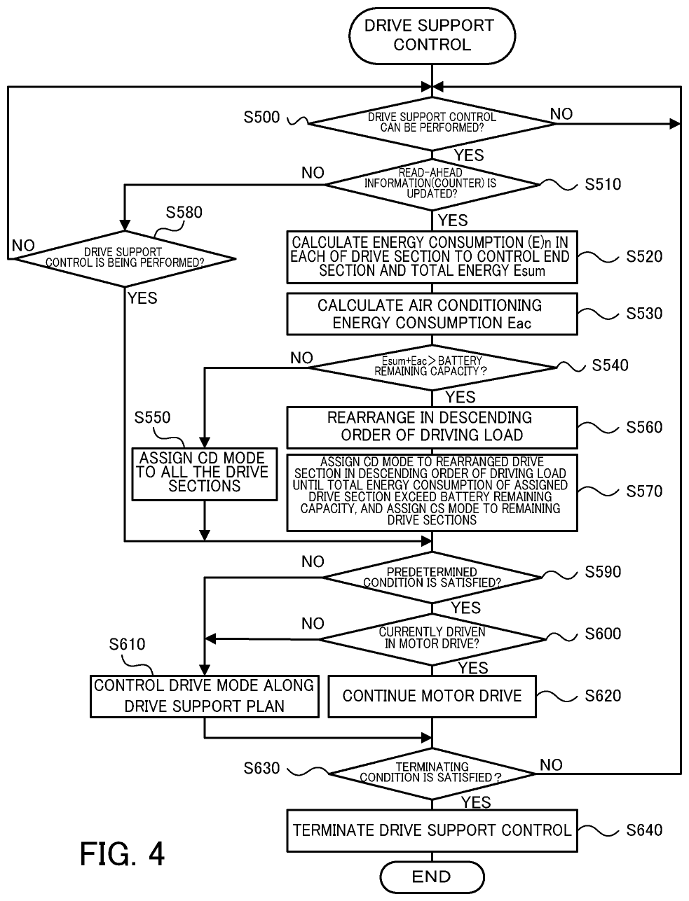

The following describes operations of the hybrid vehicle 20 of the first embodiment, particularly, the operation when the map information is updated during the drive support control. FIG. 2 is a flow chart showing one example of a drive support control performed by the HVECU 50 according to the first embodiment. This routine is performed when a destination is set, for example. FIG. 3 is a flow chart showing one example of a drive support control performed by the HVECU 50 according to the second embodiment. This routine is performed when a destination is set, for example. FIG. 4 is a flow chart showing one example of a drive support control performed by the HVECU 50 according to the third embodiment. This routine is performed when a destination is set, for example.

The drive support control of FIG. 2 is described first. The HVECU 50 first determines whether the drive support control can be performed (step S100). The drive support control assigns one of drive modes including the CD mode and the CS mode to each of drive sections of the drive route and the hybrid vehicle is driven when the drive route from the current location to the destination is set by the navigation system 80. The HVECU 50 does not perform the drive support control when the destination is not set. The HVECU 50 does not perform the drive support control when the route guidance cannot be satisfactorily performed, for example, when there is any abnormality in the navigation system 80 or the GPS 22. Further, the HVECU 50 does not perform the drive support control when the output limit Wout that is a maximum allowable output power output from the battery 40 is small due to the low temperature of the battery 40. In this state, the engine EG may be frequently started even when the hybrid vehicle is driven in the CD mode, and the hybrid vehicle cannot be driven properly in the CD mode. The HVECU 50 determines whether the drive support control can be performed at step S100 due to the circumstance described above. When it is determined at step S100 that the drive support control cannot be performed, the hybrid ECU 50 waits until the drive support control can be performed.

When it is determined at step S100 that the drive support control can be performed, the HVECU 50 determines whether the read-ahead information transmitted and received from the navigation system 80 is updated (step S110). When it is determined that the read-ahead information is updated, the HVECU 50 calculates an energy consumption E(n) in each of drive sections of the drive route from the current location to the control end section (destination), and a total energy Esum as the sum of the each energy consumption E(n) (step S120). The energy consumption E(n) in each of drive sections can be determined based on criteria such as whether the drive section is an urban area, a suburban area, or a mountainous area. The HVECU 50 subsequently calculates an air conditioning energy consumption Eac (step S130). In the first embodiment, the air conditioning energy consumption Eac is calculated by multiplying the power consumption of the air conditioning system at that time, the predetermined power consumption, the maximum power consumption of the air conditioning system, and the like by a predetermined time period (time required for driving 10 km or 15 km).

The HVECU 50 determines whether the sum of the total energy Esum and the air conditioning energy consumption Eac is larger than the remaining capacity of the battery 40 (step S140). The remaining capacity of the battery 40 can be calculated by multiplying the total capacity of the battery 40 by the state of charge SOC. When it is determined that the sum of the total energy Esum and the air conditioning energy consumption Eac is equal to or smaller than the remaining capacity of the battery 40, the HVECU 50 assigns the CD mode to all the drive sections (step S150). When it is determined that the sum of the total energy Esum and the air conditioning energy consumption Eac is larger than the remaining capacity of the battery 40, the HVECU 50 rearranges each drive sections in descending order of the driving load (energy consumption En) (step S160). The HVECU 50 subsequently assigns the CD mode to the rearranged each drive sections in descending order of the driving load until the total energy consumption En of the each assigned drive sections exceeds the remaining capacity of the battery 40, and assigns the CS mode to the remaining drive sections (step S170). Accordingly, the CD mode and the CS mode are assigned to the drive route on condition that the sum of the total energy Esum and the air conditioning energy consumption Eac is larger than the remaining capacity of the battery 40.

The HVECU 50 determines whether the predetermined time period has elapsed since the system activation, or whether the predetermined time period has elapsed since the termination of the previous drive support control (step S190). The “predetermined time period” may be a time period that does not cause a user to feel strange due to the lighting or blinking of the driving state indicator, for example, about several seconds. The HVECU 50 waits for the predetermined time period to elapse when the predetermined time period has not elapsed since the system activation, or when the predetermined time period has not elapsed since the termination of the previous drive support control. The HVECU 50 controls the drive mode along the drive support plan of the assigned mode when the predetermined time period has elapsed since the system activation or when the predetermined time period has elapsed since the termination of the previous drive support control (step S200).

When it is determined at step S110 that the read-ahead information is not updated, the HVECU 50 determines whether the drive support control is being performed (step S180). When it is determined that the drive support control is not being performed, the HVECU 50 returns the processing flow to step S100, where it is determined whether the drive support control can be performed. When it is determined at step S180 that the drive support control is being performed, the HVECU 50 determines whether the predetermined time period has elapsed since the system activation, or whether the predetermined time period has elapsed since the termination of the previous drive support control (step S190). The HVECU 50 subsequently waits for the predetermined time period to elapse since the system activation, or waits for the predetermined time period to elapse since the termination of the previous drive support control, and controls the drive mode along the drive support plan of the assigned mode (step S200).

The HVECU 50 determines whether terminating condition of the drive support control is satisfied (step S210). The terminating condition of the drive support control includes, for example, a condition when the destination is changed, a condition when the hybrid vehicle reaches the destination, a condition when the remaining capacity of the battery 40 is changed due to charging or the like, and a condition when an operation for terminating the drive support control is performed by the driver. When it is determined at step S210 that the terminating condition of the drive support control is not satisfied, the HVECU 50 returns the processing flow to step S100, where it is determined whether the drive support control can be performed. When it is determined that the terminating condition of the drive support control is satisfied, the HVECU terminates the drive support control (step S220) and terminates this routine. The HVECU 50 terminates the drive support control when the destination is changed or the remaining capacity of the battery 40 is changed due to charging or the like. The HVECU 50, however, performs the drive support control of FIG. 2 again when a drive support control should be started again.

In the hybrid vehicle 20 of the first embodiment described above, when the predetermined time period has not elapsed since the system activation, the HVECU 50 waits for the predetermined time period to elapse and the drive support control is performed. Performing the drive support control immediately after the system activation suppresses switching between the motor drive and the hybrid drive in a short time. As a result, it is possible to suppress an instantaneous lighting and blinking of the driving state indicator 67 immediately after the system activation. Further, in the hybrid vehicle 20 of the first embodiment, when the predetermined time period has not elapsed since the termination of the previous drive support control, the HVECU 50 waits for the predetermined time period to elapse and the drive support control is performed. Performing a new drive support control immediately after the termination of the drive support control suppresses switching between the motor drive and the hybrid drive in a short time. As a result, it is possible to suppress the instantaneous lighting and blinking of the driving state indicator 67 immediately after the termination of the drive support control, and to prevent the user from feeling strange.

In the hybrid vehicle 20 of the first embodiment, when the predetermined time period has not elapsed since the termination of the previous drive support control, the HVECU 50 waits for the predetermined time period to elapse and the drive support control is performed. However, the temporal hysteresis may be provided for the termination and the resumption of the drive support control. That is, once the drive support control is started, the drive support control is continued until elapse of a certain time period, and once the drive support control is terminated, new drive support control is not started until elapse of a certain time period. The “certain time period” here may be several seconds, for example.

### Second Embodiment

A hybrid vehicle 120 according to the second embodiment of the present disclosure is described next. The hybrid vehicle 120 of the second embodiment has the same hardware configuration as the hybrid vehicle 20 of the first embodiment shown in FIG. 1. In order to avoid overlapped description, the description of the hardware configuration of the hybrid vehicle 120 of the second embodiment is omitted by replacing the hybrid vehicle 20 of FIG. 1 with the hybrid vehicle 120. In the HVECU 50 of the hybrid vehicle 120 of the second embodiment, the drive support control shown in FIG. 3 is performed. The step S300 to S380 of the drive support control in FIG. 3 is similar to the step S100 to S180 of the drive support control in FIG. 2. The description of the processing of the step S300 to S380 of the drive support control in FIG. 3 is also omitted.

When the HVECU 50 assigns drive modes to each of drive sections at step S350 or S370, or determines that the drive support control is being performed at step S380, the HVECU 50 determines whether the hybrid vehicle is currently driven in the motor drive (step S390). The HVECU 50 subsequently determines whether the predetermined time period has elapsed since the start of the motor drive (step S400). The “predetermined time period” may be several seconds, for example. When it is determined at step S390 that the hybrid vehicle is not currently driven in the motor drive, or when it is determined at step S400 that the predetermined time period has elapsed since the start of the motor drive, the HVECU 50 controls the drive mode along the drive support plan (step S410). When it is determined at step S390 that the hybrid vehicle is currently driven in the motor drive and determined at step S400 that the predetermined time period has not elapsed since the start of the motor drive, on the other hand, the HVECU 50 continues the motor drive (step S420).

The HVECU 50 determines whether the terminating condition of the drive support control is satisfied (step S430). The determination of whether the terminating condition of the drive support control is satisfied is described in detail at step S210 of FIG. 2. When it is determined at step S430 that the terminating condition of the drive support control is not satisfied, the HVECU 50 returns the processing flow to step S300, where it is determined whether the drive support control can be performed. When it is determined at step S430 that the terminating condition of the drive support control is satisfied, the HVECU 50 terminates the drive support control of FIG. 3 (step S440) and terminates this routine.

In the hybrid vehicle 120 of the second embodiment described above, the motor drive is continued until elapse of the predetermined time period when the drive mode is switched to the motor drive. This suppresses switching from the motor drive to the hybrid drive in a short time after starting the motor drive. As a result, it is possible to suppress the instantaneous lighting and blinking of the driving state indicator 67, and to prevent the user from feeling strange.

### Third Embodiment

A hybrid vehicle 220 according to the third embodiment of the present disclosure is described next. The hybrid vehicle 220 of the third embodiment has the same hardware configuration as the hybrid vehicle 20 of the first embodiment shown in FIG. 1. In order to avoid overlapped description, the description of the hardware configuration of the hybrid vehicle 220 of the third embodiment is omitted by replacing the hybrid vehicle 20 of FIG. 1 with the hybrid vehicle 220. In the HVECU 50 of the hybrid vehicle 220 of the third embodiment, the drive support control shown in FIG. 4 is performed. The step S500 to S580 of the drive support control in FIG. 4 is similar to the step S100 to S180 of the drive support control in FIG. 2. The description of the processing of the step S500 to S580 of the drive support control in FIG. 4 is also omitted.

When the HVECU 50 assigns drive modes to each of drive sections at step S550 or S570, or determines at step S580 that the drive support control is being performed, the HVECU 50 determines whether the predetermined condition is satisfied (step S590). The predetermined condition includes, for example, a condition that the temperature of the battery 40 is out of a temperature range in which the function of the battery 40 can be sufficiently achieved, a condition that the distance to the border is less than the predetermined distance, and a condition that the hybrid vehicle temporarily deviates from the drive route. When it is determined at step S590 that the predetermined condition is not satisfied, the HVECU 50 controls the drive mode along the drive support plan (step S610).

When it is determined at step S590 that the predetermined condition is satisfied, the HVECU 50 determines whether the hybrid vehicle is currently driven in the motor drive (step S600). When it is determined that the hybrid vehicle is not driven in the motor drive, the HVECU 50 controls the drive mode along the drive support plan (step S610). When it is determined at step S600 that the hybrid vehicle is driven in the motor drive, the HVECU 50 continues the motor drive (Step S620). Accordingly, the HVECU 50 continues the motor drive when the hybrid vehicle is driven in the motor drive upon satisfaction of the predetermined condition. The predetermined condition includes, for example, the condition that the temperature of the battery 40 is out of the temperature range in which the function of the battery 40 can be sufficiently achieved, the condition that the distance to the border is less than the predetermined distance, and the condition that the hybrid vehicle temporarily deviates from the drive route.

The HVECU 50 determines whether the terminating condition of the drive support control is satisfied (step S630). The determination of whether the terminating condition of the drive support control is satisfied is described in detail at step S210 of FIG. 2. When it is determined at step S630 that the terminating condition of the drive support control is not satisfied, the HVECU 50 returns the processing flow to step S500, where it is determined whether the drive support control can be performed. When it is determined at step S630 that the terminating condition of the drive support control is satisfied, the HVECU 50 terminates the drive support control of FIG. 4 (step S640) and terminates this routine.

In the hybrid vehicle 220 of the third embodiment described above, the HVECU 50 continues the motor drive when the hybrid vehicle is driven in the motor drive upon satisfaction of the predetermined condition. The predetermined condition includes, for example, the condition that the temperature of the battery 40 is out of the temperature range in which the function of the battery 40 can be sufficiently achieved, the condition that the distance to the border is less than the predetermined distance, and the condition that the hybrid vehicle temporarily deviates from the drive route. This suppresses switching from the motor drive to the hybrid drive when a predetermined condition is satisfied. As a result, it is possible to suppress the instantaneous lighting and blinking of the driving state indicator 67, and to prevent the user from feeling strange.

In the hybrid vehicles 20, 120 and 220 of the embodiments, the navigation system 80 generates the read-ahead information, and the HVECU 50 creates the drive support plan and performs the drive support control. However, the navigation system 80 and the HVECU 50 may be configured as a single electronic controller and this single electronic controller may generate read-ahead information and drive support plan and perform drive support control.

In the hybrid vehicles 20, 120 and 220 of the embodiment, the navigation system 80 sets the drive route from the current location to the destination using the map information data base 84 based on information on the current location and the destination. A modification may, however, set the drive route from the current location to the destination in cooperation with the traffic information management center 100. The navigation system 80 may set the drive route by transmitting the information on the current location and the destination to the traffic information management center 100 and receiving the drive route set based on the information on the current location and the destination from the traffic information management center 100.

In the first hybrid vehicle of the present disclosure, the control device may be programmed to have a temporal hysteresis for the termination and a resumption of the drive support control. Accordingly, once the drive support control is started, the drive support control is continued until elapse of a certain time period, and once the drive support control is terminated, the drive support control is not started until elapse of a certain time period.

The present disclosure is also directed to a second hybrid vehicle. The hybrid vehicle includes an engine, a motor, a battery, map information, and a control device programmed to set a drive route from a current location to a destination, to create a drive support plan that assigns one of drive modes including a CD mode and a CS mode to each of drive sections of the drive route, and to perform drive support control that causes the hybrid vehicle to be driven along the drive support plan. The control device is programmed to continue a motor drive until elapse of a predetermined time period upon switching to the motor drive.

In the second hybrid vehicle of the present disclosure, the motor drive is continued until elapse of the predetermined time period upon switching to the motor drive. This suppresses the motor drive to be performed only for a short time. When the hybrid vehicle is equipped with a driving state indicator configured to light up during the motor drive or the hybrid drive, an instantaneous lighting and blinking of the driving state indicator can be suppressed.

In the second hybrid vehicle of the present disclosure, the control device may be programmed to set a time period required for driving in each of the drive sections to be equal to or longer than the predetermined time period. The time period required to switch between the CD mode and the CS mode is thus equal to or longer than the predetermined time period during the drive support control. As described above, since the CD mode gives a priority to the motor drive to reduce the state of charge SOC of the battery, the hybrid vehicle is basically driven in the motor drive. On the other hand, since the CS mode uses the motor drive and the hybrid drive in combination to maintain the state of charge SOC of the battery, the hybrid vehicle is basically driven in the hybrid drive. Accordingly, the time period required to switch between the motor drive and the hybrid drive is equal to or longer than the predetermined time period.

The present disclosure is also directed to a third hybrid vehicle. The hybrid vehicle includes an engine, a motor, a battery, map information, and a control device programmed to set a drive route from a current location to a destination, to create a drive support plan that assigns one of drive modes including a CD mode and a CS mode to each of drive sections of the drive route, and to perform drive support control that causes the hybrid vehicle to be driven along the drive support plan. When the hybrid vehicle is driven in a motor drive upon satisfaction of a predetermined condition, the control device is programmed to continue the motor drive.

In the third hybrid vehicle of the present disclosure, the motor drive is continued when the hybrid vehicle is driven in the motor drive upon satisfaction of the predetermined condition. This suppresses switching from the motor drive to the hybrid drive and switching between the motor drive and the hybrid drive in a short time. When the hybrid vehicle is equipped with a driving state indicator configured to light up during the motor drive or the hybrid drive, an instantaneous lighting and blinking of the driving state indicator can be suppressed.

In the third hybrid vehicle of the present disclosure, the predetermined condition may include at least one of a condition that a temperature of the battery is out of a predetermined temperature range, a condition that a distance to a border is less than a predetermined distance, and a condition that the hybrid vehicle temporarily deviates from the drive route. When the predetermined condition includes the condition that the temperature of the battery is out of the predetermined temperature range, when the temperature of the battery is out of the predetermined temperature range and the hybrid vehicle is driven in the motor drive, the motor drive is continued. On the other hand, after the temperature of the battery falls within the predetermined temperature range, the motor drive is switched to the hybrid drive. The “predetermined temperature range”, may be a temperature range capable of fully achieving a performance of the battery. When the predetermined condition includes the condition that the distance to the border is less than the predetermined distance, when the distance to the border is less than the predetermined distance and the hybrid vehicle is driven in the motor drive, the motor drive is continued. On the other hand, when the distance to the border is equal to or greater than the predetermined distance or when the hybrid vehicle crossed the border, the motor drive is switched to the hybrid drive. When the predetermined condition includes the condition that the hybrid vehicle temporarily deviates from the drive route, when the hybrid vehicle temporarily deviates from the drive route and is driven in the motor drive, the motor drive is continued. On the other hand, the motor drive is switched to the hybrid drive after the temporary deviation is eliminated.

The following describes the correspondence relationship between the primary elements of the above embodiment and the primary elements of the disclosure described in Summary. In the embodiment, the engine EG corresponds to the “engine”, the motor MG corresponds to the “motor”, the battery 40 corresponds to the “battery”, and the HVECU 50 and the navigation system 80 correspond to the “control device”.

The correspondence relationship between the primary components of the embodiment and the primary components of the disclosure, regarding which the problem is described in Summary, should not be considered to limit the components of the disclosure, regarding which the problem is described in Summary, since the embodiment is only illustrative to specifically describes the aspects of the disclosure, regarding which the problem is described in Summary. In other words, the disclosure, regarding which the problem is described in Summary, should be interpreted on the basis of the description in the Summary, and the embodiment is only a specific example of the disclosure, regarding which the problem is described in Summary.

The aspect of the disclosure is described above with reference to the embodiment. The disclosure is, however, not limited to the above embodiment but various modifications and variations may be made to the embodiment without departing from the scope of the disclosure.

### INDUSTRIAL APPLICABILITY

The technique of the disclosure is preferably applicable to the manufacturing industries of the hybrid vehicle and so on.

1. A hybrid vehicle, comprising:
an engine;
a motor;
a battery;
map information; and
a control device programmed to set a drive route from a current location to a destination, to create a drive support plan that assigns one of drive modes including a CD mode and a CS mode to each of drive sections of the drive route, and to perform drive support control that causes the hybrid vehicle to be driven along the drive support plan,
wherein the control device is not programmed to perform the drive support control until a predetermined time period has elapsed since a system activation or a termination of the drive support control.

2. The hybrid vehicle according to claim 1,
wherein the control device is programmed to have a temporal hysteresis for the termination and a resumption of the drive support control.

3. The hybrid vehicle according to claim 1,
wherein the hybrid vehicle comprises a driving state indicator configured to light up when the hybrid vehicle is driven in at least one of a motor drive and a hybrid drive.

4. A hybrid vehicle, comprising:
an engine;
a motor;
a battery;
map information; and
a control device programmed to set a drive route from a current location to a destination, to create a drive support plan that assigns one of drive modes including a CD mode and a CS mode to each of drive sections of the drive route, and to perform drive support control that causes the hybrid vehicle to be driven along the drive support plan,
wherein the control device is programmed to continue a motor drive until elapse of a predetermined time period upon switching to the motor drive.

5. The hybrid vehicle according to claim 4,
wherein the control device is programmed to set a time period required for driving in each of the drive sections to be equal to or longer than the predetermined time period.

6. The hybrid vehicle according to claim 4,
wherein the hybrid vehicle comprises a driving state indicator configured to light up when the hybrid vehicle is driven in at least one of a motor drive and a hybrid drive.

7. A hybrid vehicle, comprising:
an engine;
a motor;
a battery;
map information; and
a control device programmed to set a drive route from a current location to a destination, to create a drive support plan that assigns one of drive modes including a CD mode and a CS mode to each of drive sections of the drive route, and to perform drive support control that causes the hybrid vehicle to be driven along the drive support plan,
wherein when the hybrid vehicle is driven in a motor drive upon satisfaction of a predetermined condition, the control device continues the motor drive.

8. The hybrid vehicle according to claim 7,
wherein the predetermined condition includes at least one of a condition that a temperature of the battery is out of a predetermined temperature range, a condition that a distance to a border is less than a predetermined distance, and a condition that the hybrid vehicle temporarily deviates from the drive route.

9. The hybrid vehicle according to claim 7,
wherein the hybrid vehicle comprises a driving state indicator configured to light up when the hybrid vehicle is driven in at least one of a motor drive and a hybrid drive.
